(19) United States
(12) Patent Application Publication
(10) Pub. No.: US 2022/0156786 A1
(43) Pub. Date: May 19, 2022

(54) Systems, Methods and Media for Automatic Prioritizer

(71) Applicant: Bluecore, Inc., New York, NY (US)

(72) Inventors: Sophia Emma Nina Collet, New York, NY (US); Zahi Nadim Karam, Brooklyn, NY (US); Gino Knodel, New York, NY (US); Michael Brent Hurwitz, New York, NY (US); Victoria Leung, Wood-Ridge, NJ (US); Bahar Bipin Shah, New York, NY (US); Amber Victoria Tunnell, Brooklyn, NY (US); Max Solomon Bennett, Brooklyn, NY (US); Bryan Estes, Seattle, WA (US); Chen Chen, Queens, NY (US); Arthur Herbout, New York, NY (US)

(21) Appl. No.: 17/588,092

(22) Filed: Jan. 28, 2022

Related U.S. Application Data
(63) Continuation-in-part of application No. 16/824,446, filed on Mar. 19, 2020, now Pat. No. 11,238,502.
Application No. 16/824,446 is a continuation-in-part of application No. 16/448,419, filed on Jun. 21, 2019, now Pat. No. 11,270,340.
(60) Provisional application No. 62/828,084, filed on Apr. 2, 2019.
(60) Provisional application No. 62/693,295, filed on Jul. 2, 2018.
(60) Provisional application No. 62/828,084, filed on Apr. 2, 2019.

(51) Int. Cl. G06Q 30/02; G06N 20/00

(52) U.S. Cl. CPC G06Q 30/0244; G06N 20/00; G06Q 30/0255

(57) ABSTRACT

Exemplary embodiments include a reinforcement learning model configured at a given point in time to receive digital data about a state of a user at the given point in time, receive digital data about an environment at the given point in time, receive digital data about a campaign at the given point in time, optimize total expected future number of positive rewards at the given point in time, and to execute an action at the given point in time. The state of the user at the given point in time may be a number of communications the user has received in a particular time period, a time since a last communication, the user's past behavior, and/or the user's engagement score from a predictive model to engage with a communication.

### CROSS-REFERENCE TO RELATED APPLICATIONS

The present continuation-in-part application claims the priority benefit of U.S. Non-Provisional application Ser. No. 16/448,419 filed on Jun. 21, 2019, which claims the benefit of U.S. Provisional Application Ser. No. 62/693,295 filed Jul. 2, 2018 and U.S. Provisional Application Ser. No. 62/828,084, filed Apr. 2, 2019. The present continuation-in-part application also claims the priority benefit of U.S. Non-Provisional application Ser. No. 16/824,446, filed on Mar. 19, 2020, which claims the benefit of U.S. Provisional Application Ser. No. 62/828,084 filed Apr. 2, 2019. The foregoing cross-referenced applications are hereby incorporated by reference in their entireties.

### FIELD

The present technology relates generally to electronic communications.

### SUMMARY

This summary is provided to introduce a selection of concepts in a simplified form that are further described in the Detailed Description below. This summary is not intended to identify key or essential features of the claimed subject matter, nor is it intended to be used as an aid in determining the scope of the claimed subject matter.

In various embodiments, methods and systems for automatic frequency capping are provided. An automated decision-making process decides dynamically how often an entity should send electronic communications to any specific customer (or potential customer). An individual customer's or potential customer's optimal frequency for sending the electronic communications may be determined using machine learning. In various embodiments, the resulting target frequency for each customer (or potential customer) is personalized, and can depend on the customer's or (or potential customer's) past behavioral data such as opens/views/clicks regarding the electronic communication, on-site interactions, purchases, and other relevant data. The entity may wish to conduct an organized course of action to promote or sell a product or service, which may be referred to as a campaign. In some embodiments, the frequency may also be determined based on data for other, different campaigns and predictions on how well a particular campaign would perform based on the performance of other campaigns, as explained in detail herein.

In various embodiments, methods and systems dynamically and automatically determine a frequency for electronic communications for a campaign that is personalized for each individual customer through the configuration of the campaign.

The electronic communication as used herein may be, for example, an email message, text message, social media message, or other type of electronic message suitable for practicing various embodiments. The communication may be for marketing purposes (a marketing communication) or other purposes consistent with this specification.

In some embodiments, the method is for automatic frequency capping for a campaign and comprises receiving, from an entity, content and an audience for use for generating electronic communications for a particular campaign, the audience including at least a particular customer or a potential customer; based at least on behavior data, training a model to learn a personalized frequency for sending the electronic communications to the particular customer or the potential customer; based on the trained model, the content, and the audience, creating at least one of the electronic communications to send to the particular customer or the potential customer; and causing the at least one of the electronic communications to be sent at the personalized frequency to the particular customer or the potential customer.

In other embodiments the method comprises receiving, from an entity, a content and an audience for use for generating electronic communications for a particular campaign, the audience including at least a particular customer or a potential customer, the campaign being an organized course of action to promote and sell a product or service; based at least on behavior data, training a machine-learning model to learn a personalized frequency for sending the electronic communications to the particular customer or the potential customer; based on the trained machine-learning model, the content, and the audience, creating the electronic communications to send to the particular customer or the potential customer; and sending the electronic communications to the particular customer or the potential customer at the personalized frequency; determining value of the particular campaign; wherein the training of the machine-learning model further comprises updating the personalized frequency based on the determined value or on new data associated with one or more actions of the particular customer or the potential customer in response to receipt of the electronic communications; and sending the electronic communications to the particular customer or the potential customer at the updated personalized frequency.

In some embodiments, a system is provided comprising an automatic frequency capping service configured to: receive, from an entity, content and an audience for use for generating electronic communications for a particular campaign, the audience including at least a particular customer or a potential customer; based at least on behavior data, train a model to learn a personalized frequency for sending the electronic communications to the particular customer or the potential customer; based on the trained model, the content, and the audience, create at least one of the electronic communications to send to the particular customer or the potential customer; and cause the at least one of the electronic communications to be sent at the personalized frequency to the particular customer or the potential customer.

This summary is provided to introduce a selection of concepts in a simplified form that are further described in the Detailed Description below. This summary is not intended to identify key or essential features of the claimed subject matter, nor is it intended to be used as an aid in determining the scope of the claimed subject matter.

In various embodiments, methods and corresponding systems for Experience Optimization (EO) are provided that achieve a significant improvement over existing Send Time Optimization (STO) approaches when there are multiple send time optimized electronic communication campaigns scheduled in a given period. The given period could be a day, week, month, etc., with the period divided into slots that are divisions of the respective period (e.g., minutes, hours, days, weeks, etc.). The term “campaign” as used herein refers to an organized course of action to promote or sell a product or service. Various embodiments reduce operational overhead while also improving performance by ensuring the optimal number of communications are sent prioritized according to business or performance measures and that the send times are spaced out in a manner that strives to attain the highest value.

In various embodiments, the send times are chosen based on a global customer value function that takes into account certain customer information, their current state and the current properties of the relevant time period to make a decision. In some embodiments, the global customer value function takes into account the customer's historical online activity, their current state and the current properties of the relevant time period to make a decision.

An example method includes receiving content and an audience from an entity for use for generating electronic communications for a plurality of campaigns, the audience including at least one particular customer who is an existing customer or a potential customer; determining a number of electronic communications, for a plurality of campaigns to send to the particular customer during a particular time period; determining the optimal send time during the particular time period; determining which campaigns the particular customer is eligible for; for each determined optimal time, determining a strategy including selecting one of the electronic communications for one of the campaigns to send to the eligible particular customer so as to maximize the value over the particular time period. The example method includes causing the selected electronic communications to be sent to the particular customer at the determined send times for the determined strategies.

### BRIEF DESCRIPTION OF THE FIGURES

FIG. 1 illustrates an example system including a user interface (UI) used by a business or other entity, a campaign element, and an engine element.

FIG. 2 is an example illustrating an example of the UI in FIG. 1, wherein a user can manually select a certain time frame referred to as a “minimum time between email” (MTBE).

FIG. 3 is an example system illustrating aspects, for some embodiments, of automatic frequency capping and differences in the system compared to the system in FIG. 1.

FIG. 4 is an example system diagram illustrating certain aspects of the agent (model) for automatic frequency capping and the aspects to and from the model, according to some embodiments.

FIG. 5 illustrates an example of a pre-gate arrangement, according to example embodiments.

FIG. 6 illustrates additional aspects of the pre-gate arrangement in an overall system, according to another example embodiment.

FIG. 7 illustrates aspects of an overall system for an automatic frequency capping platform, according to various embodiments.

FIG. 8 is a simplified block diagram of a computing system, according to some embodiments.

FIG. 9 is an example diagram illustrating strategy generation for a customer, including a value function for that one customer, according to an example embodiment.

FIG. 10 shows an example schema that illustrates how certain aspects could be implemented for the same three customer strategies depicted in the example in FIG. 9.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

An entity may wish to conduct an organized course of action to promote or sell a product or service, which may be referred to as a campaign. The entity may be a business or an individual and the campaign can be, but is not necessarily, a marketing campaign since other types of campaigns fall within the scope of various embodiments of the method and corresponding system. Traditionally, the entity may desire that the campaign include electronic communications to certain intended recipients, including customers or potential customers. The entity may determine the recipients of their campaign by generating a target audience. This target audience may be defined by various conditional statements about customer's past behavior or attributes, for example, past open/click/purchase behavior, whether the customer added items to their cart, their predicted lifetime value, affinity to a certain product, etc. In some embodiments for the campaign, it can be determined that a certain electronic communication should only be sent to customers who have not received another electronic communication in a certain time frame.

The desired business outcome of a campaign is typically to maximize the likelihood of some engagement of the customer. For just one example, the reason to send a customer an electronic communication might be to inform them about products that the customer cares about which have recently been discounted; in order to achieve a particular business outcome (e.g., driving a second purchase, etc.). In this driving a second purchase example, the situation of the customer can be that of being a one-time buyer with a known preference toward a specific set of products. The desired business outcome in this particular example is to maximize the likelihood of converting one-time buyers into repeat buyers. This is just one example reason for sending the electronic communication; other reasons are well known to those in the art and/or detailed elsewhere herein.

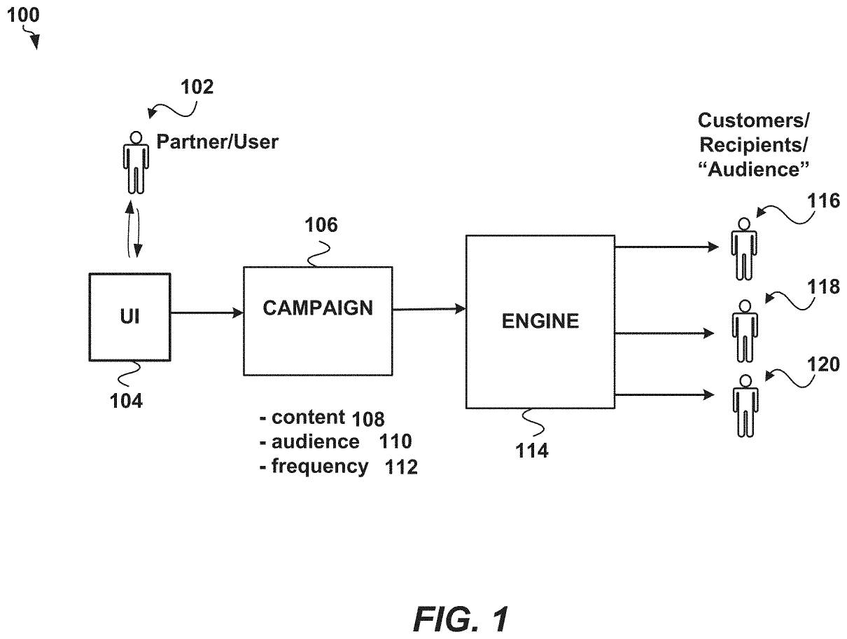

FIG. 1 illustrates an example system 100 including a user interface (UI) 104 used by a business or other entity, a campaign element, and an engine element. It should be appreciated that human (or business entity) elements shown in the figures, e.g., 102, 116, 118, 120 included in FIG. 1, are not part of the system according to various embodiments, but are included for explanatory reasons. In the example in FIG. 1, a partner/user 102 (also referred to herein as just “user” 102) can interface with the UI 104 for selecting and/or inputting aspects (content 108, audience 110 and frequency 112) of the campaign 106. An engine 114 in the example in FIG. 1 sends electronic communications to various customers/recipients/audience 116, 118, 120 (which may include potential customers). For the campaign, the user may manually input both the content for the electronic communications and the audience to receive the electronic communications. Also, in the example in FIG. 1, the user may manually select a frequency for sending the electronic communications, i.e., a manual process for selecting the frequency is used conventionally.

The electronic communication may be, for example, an email message (“an email”), text message, or other type of electronic message suitable for practicing various embodiments. The communication may be for marketing purposes (a marketing communication) or other purposes consistent with this specification.

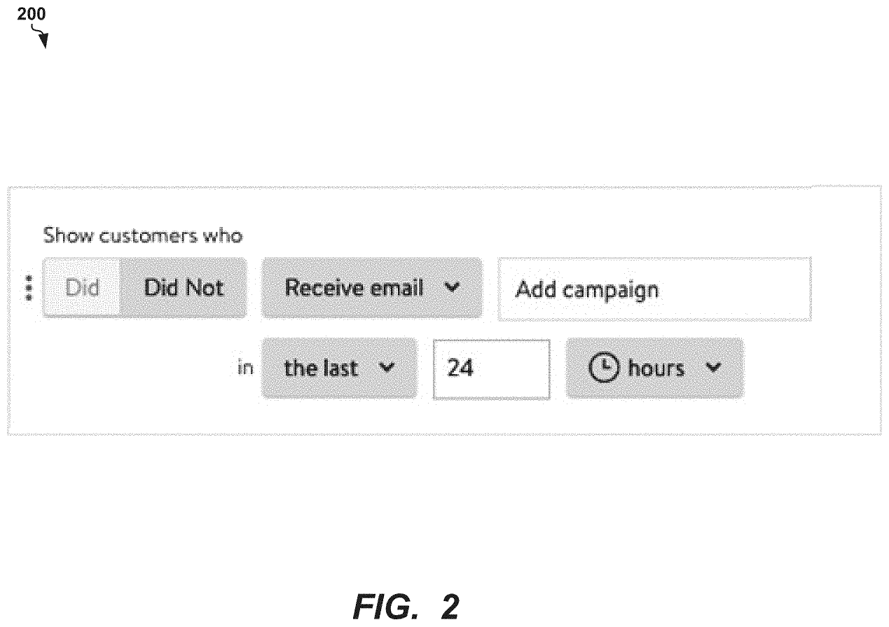

FIG. 2 is an example illustrating an example 200 of the UI in FIG. 1, wherein a user can manually select a certain time frame referred to as a “minimum time between email” (MTBE). In setting this MTBE option, a manual frequency cap on the email sends can be effectively set. In the specific example in FIG. 2, the maximum email frequency for any user will be 1 email every 24 hours. This manual selection may be just based on the user's hunch or experience, for example. Although examples herein may mention email, it should be appreciated that other types of electronic communication may be used.

According to various embodiments of the present technology, automatic frequency capping removes this manual component of setting electronic communication frequencies from the UI, and instead determines and enforces the optimal frequency automatically.

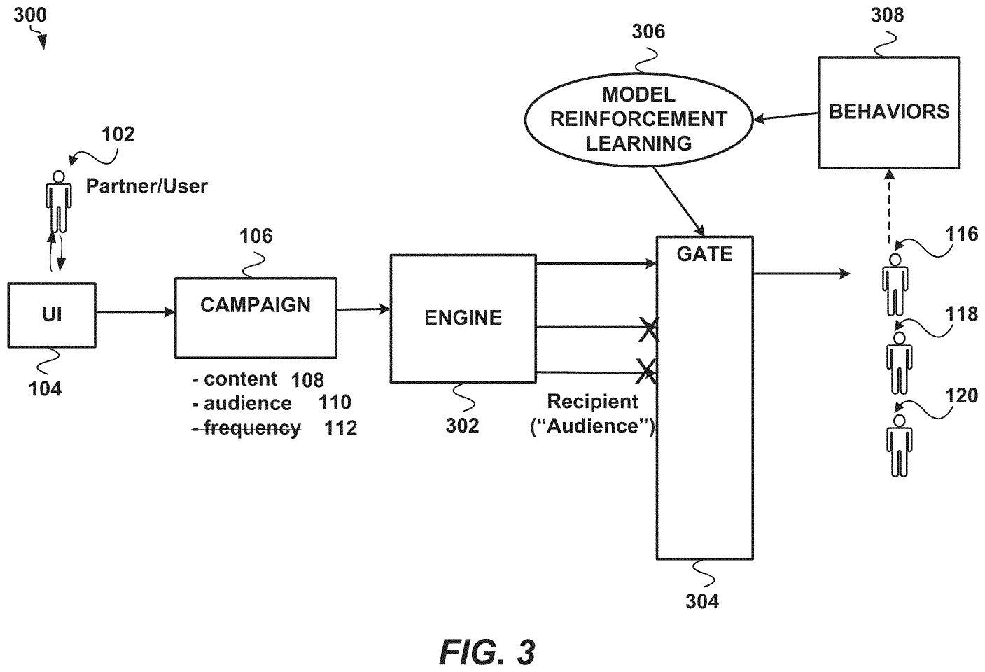

FIG. 3 is an example system 300 illustrating aspects, for some embodiments, of automatic frequency capping and differences in the system compared to the system in FIG. 1. In the figures, the “X” represents a blocking of emails. The blocking is performed by a “gate” in this example. The gate is intended to refer to an automatic means to selectively block certain emails and selectively allow other emails in this example. The strike-though of frequency 112 indicates the frequency is not manually determined by the entity for the example in FIG. 3 (in contrast to the examples in FIG. 1 and FIG. 2).

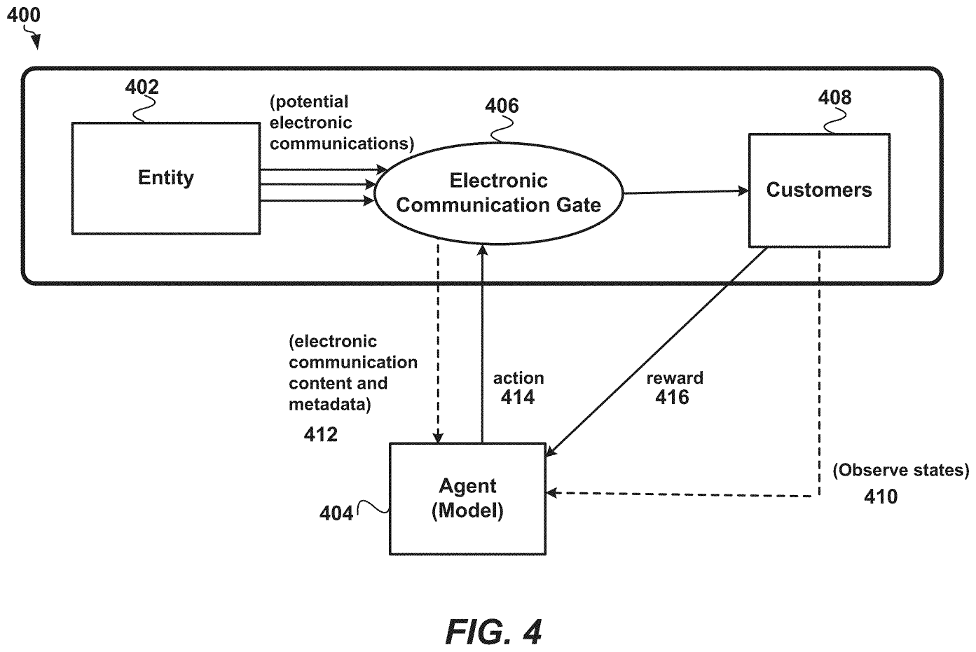

FIG. 4 is an example system diagram 400 illustrating certain aspects of the agent (model) 404 for automatic frequency capping and the aspects to and from the model 404, according to some embodiments.

With reference to FIG. 4 along with FIG. 3, some embodiments of the methods and systems for automatic frequency capping may include two main components: a reinforcement learning model (also called model reinforcement learning 306 in FIG. 3 and agent (model) 404 in FIG. 4) and a gate (304 in FIG. 3 and an electronic communication gate 406 in FIG. 4). The reinforcement learning model (e.g., 306 and 406) can act as an “agent” who at any given moment in time decides a personalized action for each customer, e.g., with respect to creating and sending (or not sending) each electronic communication to that customer. This decision can represent the agent's current view on what the optimal frequency is, and may be based on various kinds of information, including but not limited to:

(1) Type and other email metadata, and the content and timing of email, e.g., 412).

(2) The “state” of each customer, given by the entirety of a customer's historical behavioral data (behaviors 308 in the example in FIG. 3, which can also be “observe states” 410 in FIG. 4).

(3) The “reward” 416 (or outcome) the system has observed in the past after taking certain actions. Possible rewards 416 can include click, no click, purchase, and unsubscribe, to name just a few.

In operation according to some embodiments, at each iteration step, the model uses these three kinds ((1)-(3) above) of new information to adjust the model's view on what the optimal electronic communication frequency is, and to find an improved set of best actions 414 for customers. After applying these new actions 414 and waiting for some time, new rewards 416 and new states 410 can be observed, which the model 404 (306 in FIG. 3) can use to further improve the actions 414, and so on.

In some embodiments, the action 414 that the agent 404 takes are enforced by the gate (304 in FIGS. 3 and 406 in FIG. 4), which can function to allow or disallow certain electronic communications (e.g., from the entity 402 in FIG. 4) from being sent to customers 408 according to the action 414 the agent (model) 404 (306 in FIG. 3) has chosen. It should be appreciated that action 414 may encompass more than one action and the block customers 408 in this example is intended to encompass both existing customers and potential customers according to various embodiments.

In various other embodiments, that gating aspect is not used after the electronic communications are created, but rather gating may be used before the electronic communications are created, as a kind of blocking upfront, as is explained further herein.

For an entity, it is desirable to optimize certain aspects, e.g., expected future clicks of electronic communications by a customer or potential customer. The problem of optimizing expected future clicks can be phrased as a reinforcement learning problem. An agent is interacting with an environment (customers) by taking certain actions. In various embodiments, the possible actions are whether or not a customer should be marked as eligible or not eligible for an electronic communication. A goal of the reinforcement learning model according to various embodiments is to find the best action to take in any given situation.

More specifically regarding various embodiments, customers (or groups of customers) are modeled, at least in part, by assigning them a state (“S”). This state may be in general determined by a customer's historical behavioral data. In exemplary operation (see especially FIG. 4), after taking an action (“A”), a reward (e.g., click/no click/unsubscribe) is observed, and, because the customer has had time to interact with the electronic communication or website, it is consequently found that the customer is in a new state S′. Using this data, the model can find an optimal policy, which is a set of rules that map each state S to the best action A to take, in order to maximize the future reward.

Other aspects used by the model in various embodiments are explained further herein.

The model can optimize for certain data such as purchase data related to actual purchases by the recipient of the electronic communications. The model can also optimize for click data e.g., a lifetime value of clicks, which is defined as the total expected number of clicks for a customer during the entire time he/she remains subscribed to the electronic communication list. In various embodiments, this lifetime value of clicks is used, rather than, for example, just the immediate reward after a particular electronic communication is sent in order to ensure taking into account both the positive effect of clicks and the negative side effect of unsubscribes. An unsubscribed customer will neither receive nor click on any electronic communication, so according to some embodiments, an unsubscribe event constitutes a potential loss that needs to be taken into account by the model when making decisions. The result is that various embodiments of the model will choose an optimal frequency that is not too low, because it would lead to very few clicks, nor one that is too high, because it would lead to too many unsubscribes.

The model can be optimized for user-specific historical data, aggregate data on the campaign level and/or other data. Together the data can be used to determine which campaign has the highest value for a given user, from which the model in various embodiments can derive the optimal email frequency per user.

In some embodiments, the user-specific historical data may include for example: electronic communications delivery data, electronic communications open data, electronic communications click data, electronic communications unsubscribe/resubscribe data, and purchase data (online and in-store).

In some embodiments, the aggregate data on the campaign level includes for example: campaign name; campaign type (e.g. trigger vs. batch campaign); subject line; electronic communication content (e.g. recommendations, offers); schedule; past performance of other campaigns; and/or attributes of target audience (e.g. audience definition, audience size).

In some embodiments, the model is optimized for other data including: adding/removing products from cart/wishlist; on-site browsing, on-site product views (including product features such as price, category); on-site searches; other on-site behavior (e.g., filling out a survey, navigating to the help page); user reviews and explicit feedback; location and device data; and/or client-specified measures of expected campaign performance.

The model may also be optimized for: offline data (e.g., in-store visits); product returns data; user demographic data (e.g., age, location, gender); client-specific user data (e.g., loyalty status, applied for client credit card); client business goals (e.g., sell-through goals, inventory constraints, margin goals); and/or product margin data.

In some embodiments such as, for example, those in FIG. 3 and FIG. 4, after the reinforcement learning model has found the optimal policy, this policy needs to be applied to the email engine to enforce emailing each customer with his/her optimal frequency. The way the model interacts with the email engine, in various embodiments, is by setting a gate status, which determines at any moment in time if a certain customer is eligible for receiving an email or not. This means that there are two possible actions in various embodiments: gate open or gate closed. In some embodiments, at the time of generating an email audience, each customer is checked against their gate status, and only customers with status “gate open” are selected. The models 306 and 404 may, in various embodiments, include, but is not limited to, utilizing techniques such as least squares policy iteration, random forests, Q-learning, Bayesian models, support vector machines (SVM), federated learning, or neural networks.

Instead of using one global model to determine the best policy for each user, some embodiments use a multi-layered (or multi-tiered) approach.

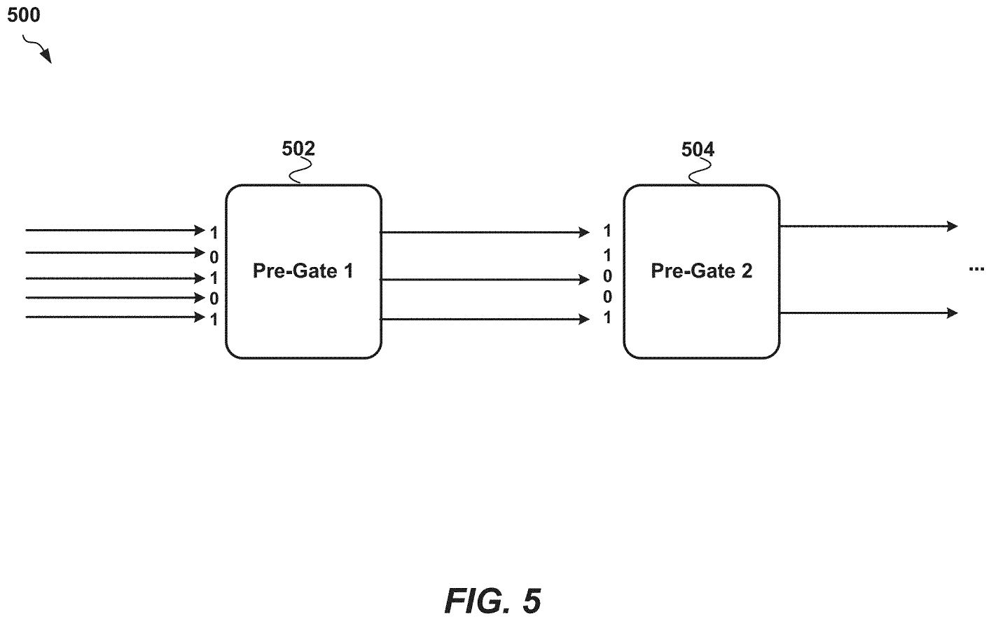

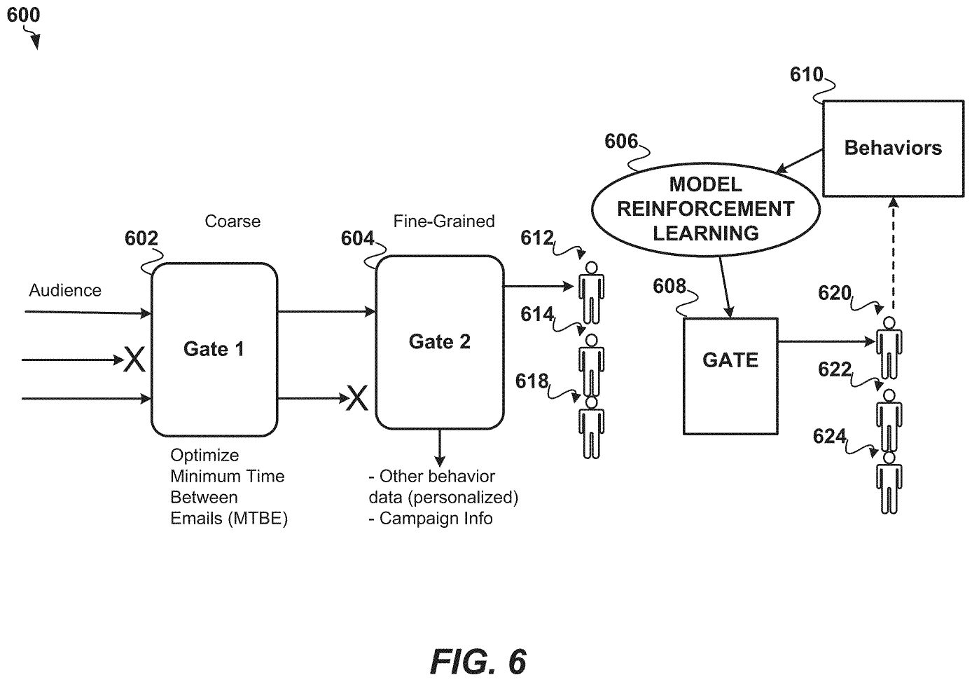

In some embodiments, this multi-layer approach having multiple levels of gates. FIG. 5 illustrates an example of a pre-gate arrangement (having a Pre-Gate 1 identified as 502, followed by a Pre-Gate 2 identified at 504). FIG. 6 illustrates additional aspects 600 of the pre-gate arrangement in an overall system according to another example embodiment. The additional aspects 600 include starting with a rough pre-filter model that makes decisions on a coarse grained level, e.g., having a model reinforcement learning 606 make decisions for controlling a coarse gate 1 identified at 602, the coarse gate 602 being part of an overall gate 608 in the example in FIG. 6. This layer can be followed by one or more fine-grained models that make decisions taking more individual-level features (as explained further below and above, including, but not limited to, behaviors 610) into account, e.g., having a model reinforcement learning 606 make decisions for controlling a fine-grained gate 1 identified at 605, the fine-grained gate 605 being part of an overall gate 608 in the example in FIG. 6. In some embodiments, the final gate status (0/1 for closed/open) is simply the product of all individual pre-gates. Because, according to some of the embodiments, actions are phrased in terms of gates, these pre-gate models can be easily layered on top of each other, so that at each stage the audience size is reduced more. This design can allow the architecture to be easily extended with more and more fine-grained model components. In general for some embodiments, the model used in each layer gets more complex from left to right, starting with a coarse pre-selection using statistical inference, to more advanced and more personalized models.

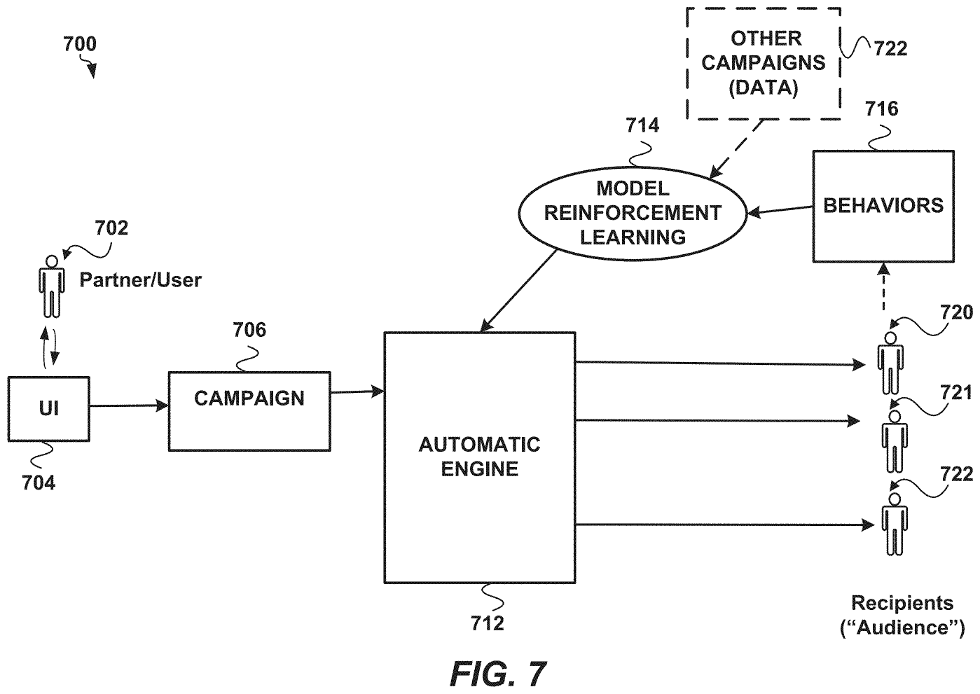

FIG. 7 illustrates aspects of an overall system 700 for an automatic frequency capping platform, according to various embodiments. It should be appreciated that human (or business entity) elements 702, 720, 721 and 722 shown in FIG. 7 are not elements of a claimed system but are included for explanatory reasons.

In the example in FIG. 7, a partner/user 702 (also referred to herein as just “user” 702 or entity 702) can interface with the UI 704 for selecting and/or inputting aspects of the campaign 706. The aspects can include, but are not limited to, content, audience, and schedule. The schedule received from the partner/user (entity) 702 in this regard refers to scheduling information other than the optimal frequency determined and provided according to various embodiments. The schedule information that may be received from the partner/user (entity) 702 can include for example, specific times to send the campaign, or a recurring time window (hourly/daily/weekly/monthly/etc). An automatic engine 712 in the example in FIG. 7 can automatically create and send electronic communications to various recipients/audience 720, 721, and 722 (which may include potential customers) at a determined frequency. In some embodiments, the electronic communications are sent by third party providers to the recipients/audience. In other embodiments, the creating and sending of the electronic communication is performed by the same party.

In various embodiments, the frequency for sending the electronic communications is determined based on a model (e.g., Model Reinforcement Learning 714, also referred to herein as model 714). The model 714 can decide at any given moment a personalized action for each customer, e.g., with respect to creating and sending each electronic communication to that customer. This decision can include and represent the model's current view on what the optimal frequency is, and may be based on various kinds of data. The data may include but not be limited to: behaviors 716 (e.g., direct feedback from recipient's actions or inactions). In some embodiments, the data provided to the model 714 may also include and in some embodiments, data from other campaigns.

Instead of selecting users/electronic communications and then selectively blocking them as in some other embodiments, the model 714 and automatic engine 712 can provide a mechanism such that users who should not get electronic communications in the first place are not selected, e.g., only electronic communications that will be sent to a recipient will be created. This mechanism for the combination of the model 714 and automatic engine 712 can be implemented via an SQL query in some embodiments.

The automatic engine 712, in various embodiments, determines the frequency for sending electronic communications based on the model 714, so as to provide an automatic and more personalized approach for sending electronic communications to the recipients 720, 721, and 722 in the example in FIG. 7.

The frequency for sending electronic communications can be optimized for certain metrics which can include, for example, behaviors 716. At least some of the behaviors 716 provide direct feedback from the recipients 720, 721, and 722.

The model 714 can be optimized for user-specific historical data, aggregate data on the campaign level and/or other data. Together the data can be used to determine which campaign has the highest value for a given user, from which the model in various embodiments can derive the optimal email frequency per user.

The user-specific historical data may include for example: electronic communications delivery data, electronic communications open data, electronic communications click data, electronic communications unsubscribe/resubscribe data, and purchase data (online and in-store).

In some embodiments, the aggregate data on the campaign level includes for example: campaign name; campaign type (e.g. trigger vs. batch campaign); subject line; electronic communication content (e.g. recommendations, offers); schedule; past performance of other campaigns; and/or attributes of target audience (e.g. audience definition, audience size).

The model 714 can be optimized for other data including: adding/removing products from cart/wishlist; on-site browsing, on-site product views (including product features such as price, category); on-site searches; other on-site behavior (e.g., filling out a survey, navigating to the help page); user reviews and explicit feedback; location and device data; and/or client-specified measures of expected campaign performance.

In various embodiments, the model 714 is also optimized for: offline data (e.g., in-store visits); product returns data; user demographic data (e.g., age, location, gender); client-specific user data (e.g., loyalty status, applied for client credit card); client business goals (e.g., sell-through goals, inventory constraints, margin goals); and/or product margin data.

The historical data may also include data from other campaigns (722 in FIG. 7) and can include data from the current campaign. Regarding other campaigns, the historical data can include which are the campaigns that tend to perform very well by making people click on their electronic communications or purchase a product; which are the campaigns that do not perform very well, and other characteristics. Regarding data from the current campaign, for example, a user could set up a “weekly bestseller campaign”, which may send different looking electronic communications to a changing audience each week. Although one could technically define each weekly send as its own “campaign” for this example, those weekly sends are generally understood to be part of the same campaign. This means that, for this example, the model can predict the future performance of the weekly campaign based on how well this same campaign has done in the previous weeks.

Based on the historical data, various embodiments use the model 714 to make a prediction on whether the present campaign is going to be a high value or a low value campaign. This learning from data for other campaigns and/or from the current campaign can be very powerful. For example, especially if an entity may have a hundred other campaigns already executed from which much can be learned. In various embodiments, at least some of the settings for those other campaigns are determined, e.g., schedule sending monthly or weekly for the campaign; does the other campaign have recommendations, dynamic content, or other notable features. Based at least in part on these settings, other characteristics of the other similar campaigns, and/or data from the current campaign, the methods according to various embodiments predict what is the expected performance of the current campaign. e.g., based on how well other campaigns have done in the past and/or how the current campaign has done in the past. For example, if last year, an entity initiated a Black Friday campaign with a discount and that campaign performed very well, then even though it has not been tried yet, a similar campaign should predictably do well again in the current year. For another example, if the weekly sends of a “weekly bestseller campaign” have performed well, future weekly sends of that same campaign should predictably also do well. This historical data, for other campaigns and for the same campaign, can be another ingredient to the model, e.g., model 714 in the example in FIG. 7.

Results from similar other campaigns and the similarities in the settings between other campaigns and the new campaign may be weighted to make the prediction. This prediction may be used to assess how the new campaign is performing against the prediction. Similarly, results from prior sends of the same campaign and similarities in the settings between prior recurring sends and new sends for the same campaign may also be part of the weighting for making the prediction.

In some embodiments, data is combined (both on a customer and a campaign level) across different entities (also referred to herein as partners). Using the combined data, the model may still use campaign level data to predict how well campaigns will do and combine it with customer data to select the best frequency for each customer/potential customer. However, by using data from different partners, some embodiments can transfer some of the learnings between different partners. For example, if a particular partner has never sent a Black Friday electronic communication before, but much data has been collected on other partners' Black Friday electronic communications and there is knowledge that this type of campaign tends to perform well, this insight can be used in some embodiments to predict that the given partner's campaign will also do well. For another example on the user level, if it is known from other partners' data that a given user likes to receive a lot of electronic communications and therefore his/her ideal electronic communication frequency is high, some embodiments use this knowledge from one partner for automatically determining the frequency to use for a campaign of another partner, even if that other partner has never sent an electronic communication to that particular user before.

The model in various embodiments could also be used to determine which configuration settings for a campaign have the highest value. Determination of the highest value with respect to campaigns is also discussed in Application No. 62/828,084, filed Apr. 2, 2019, which is incorporated by reference herein in its entirety. For example, if it is determined that a particular frequency of sending electronic communications does not interfere with other campaigns that the entity is doing, then this particular frequency may be preferred.

The predictive aspects of the model 714 can anticipate how a current campaign will do, and if, for example, the current campaign is predicted to be a high value campaign, then the current campaign can be prioritized, e.g., increasing the frequency of sending electronic communications. On the other hand, if the model 714 predicts that the current campaign is a low value campaign, then the frequency of sending electronic communication for this campaign can be lowered resulting in fewer electronic communications being sent for the low value campaign.

The model 714 according to example embodiments may include and/or utilize various machine learning techniques including, but not limited to techniques such as least squares policy iteration, random forests, Bayesian, support vector machines (SVM), federated learning, or neural networks.

The models 306 and 404 may, in various embodiments, include, but are not limited to, utilizing techniques such as least squares policy iteration, random forests, Q-learning Bayesian models, support vector machines (SVM), federated learning, or neural networks.

The model's automatically determining of the frequency of an electronic communication can be based on the prediction, e.g., the likelihood and predictive value.

Behavior data can include, in addition to data regarding past campaigns, new data concerning actions or inaction of the current customer of the campaign, e.g., opening the electronic communication, past clicks on the electronic communication, and associated purchases made. In addition, the behavior data could also include what the customer is clicking on within a website, purchase actions, placing a product or service in a cart online, browsing from a general webpage having a number of products to a webpage for a particular product, putting an item in the cart but not purchasing, unsubscribing or otherwise blocking future electronic communications, and other available data.

In some embodiments, the model is optimized based on whatever the most data is available for. For example, for entities for which there is a lot of available purchase data, the model can optimize based on the purchase data. On the other hand, if purchases are rare for some entities, e.g., new entities or new class of products/services where past purchases are rare or the nature of the product/service is that a very limited number of purchases are made, then the model may be optimized for click data or whatever data is available that works best for the particular entity. In some embodiments, the data used by the model is a metric based on characteristics of the particular entity, e.g., selling high priced item for which purchases are infrequent.

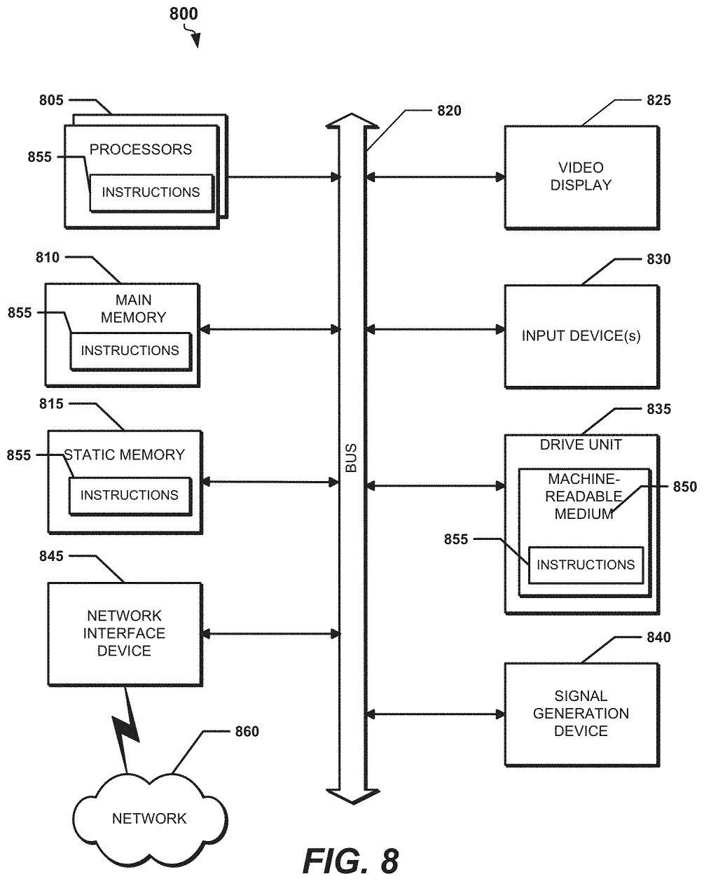

FIG. 8 illustrates an exemplary computer system 800 that may be used to implement some embodiments of the present invention. The computer system 800 in FIG. 8 may be implemented in the contexts of the likes of computing systems, networks, servers, or combinations thereof. The computer system 800 in FIG. 8 includes one or more processor unit(s) 810 and main memory 820. Main memory 820 stores, in part, instructions and data for execution by processor unit(s) 810. Main memory 820 stores the executable code when in operation, in this example. The computer system 800 in FIG. 8 further includes a mass data storage 830, portable storage device 840, output devices 850, user input devices 860, a graphics display system 870, and peripheral device(s) 880.

The components shown in FIG. 8 are depicted as being connected via a single bus 890. The components may be connected through one or more data transport means. Processor unit(s) 810 and main memory 820 are connected via a local microprocessor bus, and the mass data storage 830, peripheral device(s) 880, portable storage device 840, and graphics display system 870 are connected via one or more input/output (I/O) buses.

Mass data storage 830, which can be implemented with a magnetic disk drive, solid state drive, or an optical disk drive, is a non-volatile storage device for storing data and instructions for use by processor unit(s) 810. Mass data storage 830 stores the system software for implementing embodiments of the present disclosure for purposes of loading that software into main memory 820.

Portable storage device 840 operates in conjunction with a portable non-volatile storage medium, such as a flash drive, floppy disk, compact disk, digital video disc, or Universal Serial Bus (USB) storage device, to input and output data and code to and from the computer system 800 in FIG. 8. The system software for implementing embodiments of the present disclosure is stored on such a portable medium and input to the computer system 800 via the portable storage device 840.

User input devices 860 can provide a portion of a user interface. User input devices 860 may include one or more microphones, an alphanumeric keypad, such as a keyboard, for inputting alphanumeric and other information, or a pointing device, such as a mouse, a trackball, stylus, or cursor direction keys. User input devices 860 can also include a touchscreen. Additionally, the computer system 800 as shown in FIG. 8 includes output devices 850. Suitable output devices 850 include speakers, printers, network interfaces, and monitors.

Graphics display system 870 include a liquid crystal display (LCD) or other suitable display device. Graphics display system 870 is configurable to receive textual and graphical information and processes the information for output to the display device. Peripheral device(s) 880 may include any type of computer support device to add additional functionality to the computer system.

Some of the components provided in the computer system 800 in FIG. 8 can be those typically found in computer systems that may be suitable for use with embodiments of the present disclosure and are intended to represent a broad category of such computer components. Thus, the computer system 800 in FIG. 8 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including MAC OS, UNIX, LINUX, WINDOWS, PALM OS, QNX, ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 800 may be implemented as a cloud-based computing environment, such as a virtual machine operating within a computing cloud. In other embodiments, the computing system 800 may itself include a cloud-based computing environment, where the functionalities of the computing system 800 are executed in a distributed fashion. Thus, the computing system 800, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 800, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, e.g., optical, magnetic, and solid-state disks, such as a fixed disk. Volatile media include dynamic memory, such as system random-access memory (RAM). Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, e.g., a floppy disk, a flexible disk, a hard disk, magnetic tape, any other magnetic medium, a CD-ROM disk, digital video disk (DVD), any other optical medium, any other physical medium with patterns of marks or holes, a RAM, a programmable read-only memory (PROM), an erasable programmable read-only memory (EPROM), an electrically erasable programmable read-only memory (EEPROM), a Flash memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as PYTHON, RUBY, JAVASCRIPT, JAVA, SMALLTALK, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Other known solutions are limited to handling one campaign in a predetermined time frame. For multi-campaigns, the client is typically asked to specify different non-overlapping time windows for each of the campaigns; otherwise a given user will receive either only one of the communications or multiple electronic communications at the same time. The service provider for the electronic communications may then take care of choosing the best time to send an electronic communication to the customer in each time window. For known solutions, the methods for choosing the “best” time are not robust enough for the multi-campaign case to determine the time that is best for optimal value in terms of the probability of engaging the particular customer or potential customer. Additionally, there is a significant operational overhead for the client in having to specify non-overlapping time frames in the multi-campaign case. What is needed is an improved solution for the multi-campaign case where there is a plurality of campaigns for which electronic communications are to be sent.

In various embodiments, the methods and corresponding systems for providing experience optimization comprise a model that decides the best communication schedule for each person (e.g., each potential recipient of a communication). The model can decide for each person when to send which communication. In operation in various embodiments, this decision of the model will not be restricted to one campaign sent over a certain time period or time interval: the model may make a decision at each time interval whether to send a communication or not. Therefore, the whole model, in various embodiments, effectively decides how many communications should be sent and at what times of the time period the communications should be sent to optimize for total engagement over the time period. The communication may be, for example, an email message, text message, or other type of messages electronic or otherwise non-electronic messages suitable for practicing various embodiments. The communication may be for marketing purposes (a marketing communication) or other purposes consistent with this specification.

Various terminology as used herein for various embodiments:
Send Time Value Function: a function defined over the certain time period or time interval that indicates the value of each given time interval of a fixed length, in terms of engagement (can include, but is not limited to value in terms of clicks, purchases or revenue). The time interval could be an hour, a day, a month, a year; other suitable time intervals may be used in other embodiments. In some embodiments, this value function may be defined in a personalized way and may depend on the person who is the intended recipient of the communications. This value function may also be defined within a date context: the value function may vary depending on the day of the week, or week/month of the particular year. The value function may be precomputed in some embodiments of the present technology and may be computed in real time (e.g., on the fly) in other embodiments.
Customer-proper attributes: characteristics of the customer including but not limited to age, gender, location (e.g., zip code), and/or product or campaign affinities of the intended recipient.
Behavior: including but not limited to online and offline behavior. Online Behavior can be a collection of online actions that a customer can perform and that various embodiments track. The collection includes, but is not limited to, opens or clicks on a communication, view/cart/purchase of a product or a search on the client's website. The actions in the collection are first party data that is collected on behalf of clients by the provider, or third party data collected by others. Offline Behavior can include various data concerning customers visiting brick and mortar stores, making purchases from such stores, and/or joining a loyalty program, to name just a few examples.
Campaign Value: The value of a communication campaign can be defined in a multitude of ways including the engagement that can be expected when a given electronic communication is sent. This could be personalized such that the value of a campaign could not only be relative to the type of campaign itself, but also be relative to the intended recipient (customer or potential customer) of the communication (e.g., depending on the intended recipient's behavior and customer-proper attributes, to name just two examples). The Campaign Value can also be based on a business outcome, such as sell-through or margin goals.
Time Between Communications (TBC): time lapse between the reception of consecutive communications for a customer of a client.
Minimum Time Between Communications (MTBC): minimum allowed time between communications. For various embodiments, the MTBC can be set via multiple methods. For one, a client's global MTBC can be configured for global use to prevent any communication from being sent if the previous communication sent was less than MTBC time units before. In addition, each campaign can have custom MTBCs set up. The custom MTBC could be an MTBC that is configured to prevent the communication of that campaign from being sent if the customer (e.g., intended recipient) had received any other communications less than x time units earlier (x being selectable for customization). The custom MTBC may be set by automatic frequency capping. For background purposes only, it is noted that automatic frequency capping is further described in pending U.S. patent application Ser. No. 16/448,419, filed Jun. 21, 2019 which claims the benefit of U.S. Provisional Patent Application No. 62/693,295, filed Jul. 2, 2018. Another MTBC that may be used is configured to prevent the communication of that campaign from being sent if the customer got a specific type of communication less than a certain amount of time earlier, e.g., less than x hours earlier.

Messages in one-time and recurring campaigns system were historically scheduled by the client to send at a given time and cadence or frequency, e.g., noon on a given day or daily/weekly/monthly at 5 p.m. or every hour.

The methods and systems in various embodiments wake up at a given time-interval and for each of the campaigns scheduled to go out at that time, finds all the customers that qualify for the campaign. Whether a customer qualifies for a campaign is based on the audience that the client defines, as well as the MTBC setting.

According to various embodiments, a client no longer needs to set the time of day that the client wishes to send the communication. Instead, the client can set just the time period, e.g., day, or the cadence, e.g., daily/weekly/monthly. Various embodiments will then decide on a per-customer basis what is the best time to send the communication. If a client has multiple campaigns (e.g., a multi-campaign) scheduled for the same time period, a customer could end up qualifying for more than one of these campaigns. Therefore, various embodiments decide how many communications that customer will receive as well as the best time to send each of the communications; this decision is made in a manner that maximizes value over the whole time period. The value may be in terms of engagement of a customer including, for example, number of clicks, purchases or revenue.

In various embodiments, for each customer, the methods and systems determine an estimate of the value of each time unit (probability to engage at each time unit for that person). This can provide a value function (defined over the time period) for each customer that would indicate how valuable sending a communication at a certain time would be for that person. This value function can also depend on a broader date context, for instance, which day of the week or which week/month of the year the date is in. The value function may also take into account periodicity and seasonality. This value function may be determined using a machine learning model trained on historical data (e.g., past delivered times and other online behavior such as opens, clicks, purchases, etc.) and could be personalized (for instance taking into account customer-specific attributes and online/offline activity, to name just a few examples). Demographic and profile information for the particular customer may be used in the determination of the value function and resultant best send time. In some embodiments, these additional online activities may be used to group people together and find a common value function for people that show similar behavioral patterns (e.g., browsing the same website at the same time during the day).

Based on the determined value function, various embodiments select the best combination of x time slots (for x going from 1 to the maximum number of time optimized combinations, it is desired that the customer receive within one time period) to maximize engagement over the whole time period. In order to determine the best combination, various embodiments determine a function that gives the probability of a communication being sent (e.g., not being blocked by MTBC filters) for each TBC. The x-length tuple of times will be referred to as “strategy x”, according to various embodiments. This can result in several tuples of distinct lengths.

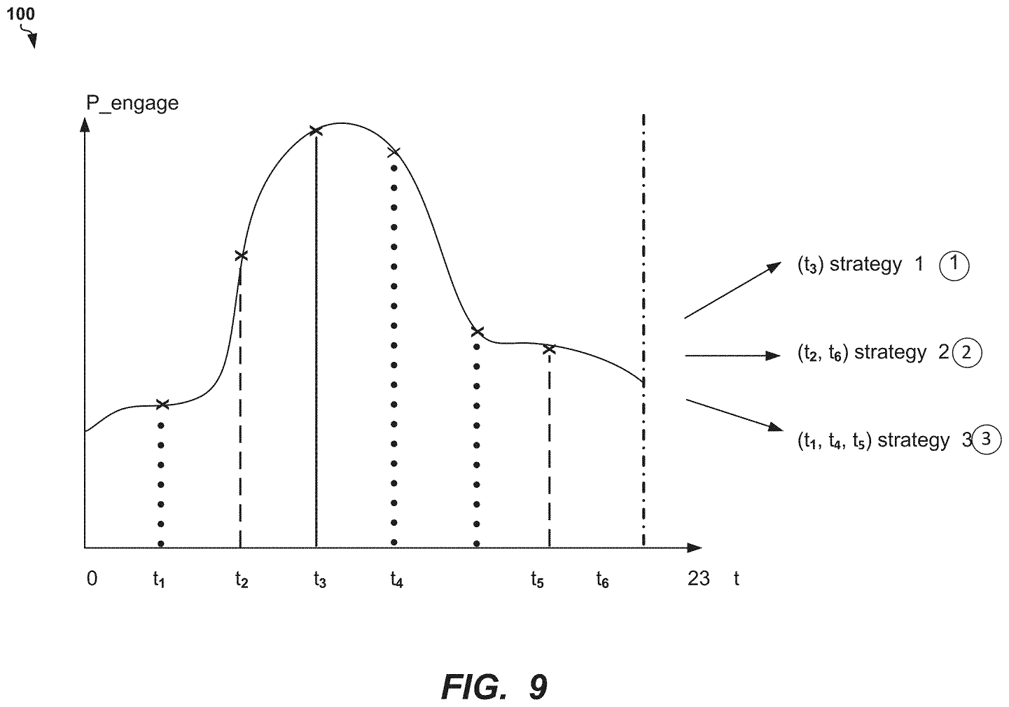

FIG. 9 is an example diagram 100 illustrating strategy generation for a customer graphing the value function for one customer over a certain time period. In the example in FIG. 9, the time period is one day with 24 hour-long intervals, though the present technology is not limited to that example period and example intervals. In addition, the example in FIG. 9 shows a maximum of three send times per strategy but the present technology is not so limited. As explained above, the number of send times can be as high as how many defined time intervals can be present within the time period (e.g., within a day for the example in FIG. 9). For instance, if time intervals are defined to be hours, the maximum number of times could be 24. The value function and strategies may be precomputed in some embodiments and they may be computed in real time (e.g., on the fly) in other embodiments.

The resulting strategies in the example in FIG. 9 are:
Strategy 1: send one communication at time (t3).
Strategy 2: send two communications, at times (t2, t6), respectively.
Strategy 3: send three communications, at times (t1, t4, t5), respectively.

There may be common hours across strategies (for instance, in the example in FIG. 9, t3 may replace t2 in strategy 2 which would have a common hour with strategy 1, or may replace t3 with t6 to have a common hour between strategy 1 and strategy 2.

A decision between strategies (e.g., regarding the number of communications to send: one communication, two communications, or x communications) may be made by looking at the customer state at each time during the time period that the customer is eligible for a campaign send. In various embodiments, the customer state is defined by customer eligibility. For example, the total number of campaigns the user is eligible for at that point in time can be necessary for defining the customer state since eligibility is essential in various embodiments. In other embodiments, the customer state may be defined by other attributes including but not limited to the value of the campaign(s) to which the customer is eligible; customer-proper attributes (such as age, gender, and product affinities to name just a few); customer online/offline activity, and optional attributes such as how late/early it is in the day, how many communications in each strategy are left, etc. Although the term “customer” is used, it should be appreciated that this may also be a potential customer who is not currently a customer. Based on the values for the attributes, the value of sending/not sending is estimated and a decision is made based on the estimate. In various embodiments, this decision effectively selects one of the strategies, which will then be followed (if possible, depending on eligibility, for instance) throughout the day.

In some embodiments, if for a given time, the decision is to send a communication and the customer is eligible for multiple campaigns, a decision is made as to which campaign of the multiple available campaigns to send (e.g., which campaign's communication to send). The decision on which of the campaigns to send can be based on which campaigns the customer is eligible for at that particular time, and those campaigns' values for that customer. In various embodiments, the operation of deciding which campaign is preferred over another can be made either using a global model or a personalized model, where the model can be trained based on first party or third party data to make the best decision for each customer.

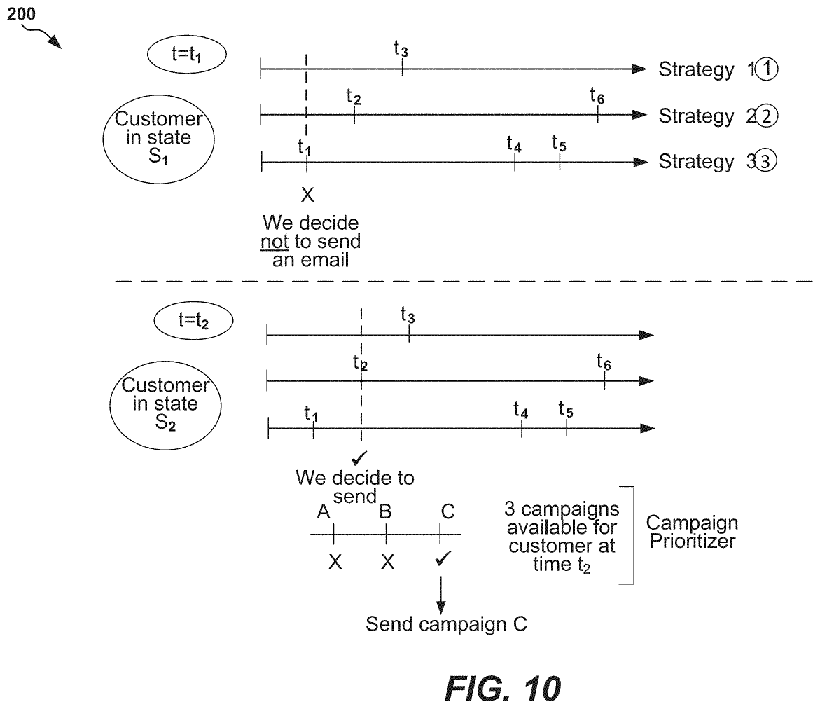

FIG. 10 is a diagram 200 of an example schema that illustrates the operation of certain aspects for the same three customer strategies depicted in FIG. 9. In various embodiments, the method includes pre-generating all possible audiences for each campaign at each time interval (e.g., an hour in the example in FIG. 10) and then making a decision on whether or not to send the campaign.

In the example in FIG. 10, strategy 2 (communications at send times t2 and t6) can be chosen as the strategy to follow for this day. As can be seen, the decision whether to send depends on customer state (e.g., not send at time t=t1 if customer state is state S1 in the example in FIG. 10). At time t=t2, the customer state is S2 and a determination is made to send an electronic message for this time and state. A decision is made in this example, as to which of the multi-campaigns to send and campaign C was chosen. In accordance with strategy 2, after time t2, there will not be a send at time t3, time t4, or time t5. However, when time t6 is reached, a communication will be sent if possible (e.g., depending on customer state, for instance, if the user is eligible for any campaign at that time and other attributes are proper). Various customer state attributes are explained further above.

If the user is eligible for multiple campaigns at t6, the most valuable one is chosen (campaign C is excluded—even if the user is eligible for campaign C at t6 and even if campaign C was determined to be the most valuable one—since campaign C has already been sent at t2).

In some embodiments, if the time period is approaching the end (e.g., last hour of the day where time period is a day) and a particular customer is eligible to receive a communication during that time period for a particular campaign, then the communication may be sent even if that last hour is not necessarily the optimal send time.

Exemplary embodiments include a reinforcement learning model configured at a given point in time to receive digital data about a state of a user at the given point in time, receive digital data about an environment at the given point in time, receive digital data about a campaign at the given point in time, optimize total expected future number of positive rewards at the given point in time, and to execute an action at the given point in time. In various exemplary embodiments, the action may be prioritizing between communications, e.g., picking one or more communications to display, send or transmit over one or more other communications. The state of the user at the given point in time may be a number of communications the user has received in a particular time period, a time since a last communication, the user's past behavior, and/or the user's engagement score from a predictive model to engage with a communication.

The environment, according to various exemplary embodiments, may be a date and time. The digital data about the campaign may be a campaign type. The digital data about the campaign may be the user's past interaction with the campaign, the user's past interaction with other campaigns, a plurality of users' past interactions with the campaign, and/or a plurality of users' past interactions with other campaigns. The action may be transmitting a communication or refraining from transmitting a communication.

The reinforcement learning model, according to various exemplary embodiments, may include the reinforcement learning model configured to receive digital data about a constraint. The constraint may be a maximum number of communications to send in a particular time period. The reinforcement learning model may be configured to aggregate data from multiple clients. In some exemplary embodiments, a client may be a distinct source of data.

Additionally, the reinforcement learning model may be a neural network. A neural network is a framework of machine learning algorithms that work together to predict an outcome based on a previous training process. The reinforcement learning model may be configured at the given point in time to perform a comparison of an output of the reinforcement learning model to an actual output generated from application of the output. The reinforcement learning model may be configured at the given point in time to update to the reinforcement learning model.

In various exemplary embodiments, the total expected future number of positive rewards at the given point in time may be calculated by weighing a value of sending or displaying an immediate campaign against lowering a value of sending another campaign in the near future if the immediate campaign is sent. Additionally, the total expected future number of positive rewards at the given point in time may be calculated by weighing a value of sending an immediate campaign that exhausts a constraint against precluding a sending of another campaign having a higher value. The total expected future number of positive rewards at the given point in time may be calculated by weighing a value of sending an immediate campaign against a possibility of adversely impacting a user state (e.g., lowering engagement or unsubscribing). The total expected future number of positive rewards at the given point in time may be calculated by weighing a value of sending an immediate campaign against a possibility of positively impacting a user state (e.g., a user goes to a website, finds a coupon and makes a purchase).

For each user, according to various exemplary embodiments, a catalog of campaigns may be sent to them, plus some optional constraints. These constraints could be the maximum number of communications allowed to be sent in one month, week, day, etc., or certain hours of the day that communications should never be sent. The idea is that these constraints are very loose business constraints that provide guardrails, but are not finely tuned or optimized. These campaigns could be defined on multiple devices, e.g., smart devices, televisions, or channels (they can result in sends via different kinds of communications, like emails, mobile device applications, websites, virtual or augmented reality and/or short message service (“sms”)).

If a low-value email (or other form of communication) is sent right now, that may max out a constraint of not sending more than X emails in a week, which may preclude sending a high-value communication later, which may reduce the overall reward. In a similar fashion, different sets of constraints may be simulated, and if it is determined that it would help the model to loosen some of the constraints (e.g. allow it to send more emails per week), this would be another useful piece of information to relay back to a marketer. In various exemplary embodiments, at regular time intervals, the model “wakes up” and decides what is the best action to take in order to increase the overall reward over a long time period, based on features of the user, the campaign and the environment at this moment.

More specifically, according to exemplary embodiments, the actions the model may take are to either send one of the available campaigns, or to “abstain” and not send anything. The metric that the model optimizes for is the total expected number of positive rewards over a given time period, where the definition of a positive reward is set by the marketer. For example, this could be conversions, clicks, opens, leaving a review, providing PII, margin (revenue generated by the communication minus the cost of sending the communication) etc.

Based on this information, the model (a general reinforcement learning model, possibly of the neural network kind but not necessarily) calculates the value of each action it can take (action 0: abstain, action 1: send campaign 1, action 2: send campaign 2, . . . ). The value here is forward looking, i.e., it is the immediate expected reward from sending this campaign plus all expected rewards in the future, based on the new state that this action will put the user and environment in.

According to some exemplary embodiments, to account for the future rewards, the model may have to execute some complex calculations, like:

If campaign X is sent right now, could it lower the value of sending another campaign in the immediate future, which may otherwise have had higher value? The example here could be if an email is sent during the week and the user opens it, the user may become less likely to also open an email on the weekend, where they may be more likely to click on it and make a purchase.

If a low-value email is sent right now that maxes out a constraint of not sending more than X emails in a week, will sending a high-value trigger later be precluded, which will reduce the overall reward?

In most exemplary embodiments, the system determines the combinations of times that maximize a value function. This depends on engagement but can also depend on other factors. Even if customer engagement reaches 100% probability at specific combinations of time intervals, nothing guarantees that it is these combinations where the overall “values of a value function” are maximized, or that the determining of optimal times is solely based on these combinations.

Further, limitations such as “ . . . for a time interval of the time intervals, the value function is a probability that the at least one particular customer person engages in the electronic communications at the time interval by at least opening the electronic communications on the computing device;” does not imply that the value function/probability of engagement can even reach 100%. What is clear is that the value function can vary throughout the day and may have one or several maxima.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A reinforcement learning model configured at a given point in time:
to receive digital data about a state of a user at the given point in time;
to receive digital data about an environment at the given point in time;
to receive digital data about a campaign at the given point in time;
to optimize total expected future number of positive rewards at the given point in time; and
to execute an action at the given point in time.

2. The reinforcement learning model of claim 1, wherein the state of the user at the given point in time is a number of communications the user has received in a particular time period.

3. The reinforcement learning model of claim 1, wherein the state of the user at the given point in time is a time since a last communication.

4. The reinforcement learning model of claim 1, wherein the state of the user at the given point in time is the user's past behavior.

5. The reinforcement learning model of claim 1, wherein the state of the user at the given point in time is the user's engagement score from a predictive model to engage with a communication.

6. The reinforcement learning model of claim 1, wherein the environment is a date and time.

7. The reinforcement learning model of claim 1, wherein the digital data about the campaign is a campaign type.

8. The reinforcement learning model of claim 1, wherein the digital data about the campaign is the user's past interaction with the campaign.

9. The reinforcement learning model of claim 1, wherein the digital data about the campaign is the user's past interaction with other campaigns.

10. The reinforcement learning model of claim 1, wherein the digital data about the campaign is a plurality of users' past interactions with the campaign.

11. The reinforcement learning model of claim 1, wherein the digital data about the campaign is a plurality of users' past interactions with other campaigns.

12. The reinforcement learning model of claim 1, wherein the action is transmitting a communication.

13. The reinforcement learning model of claim 1, wherein the action is refraining from transmitting a communication.

14. The reinforcement learning model of claim 1, further comprising the reinforcement learning model configured to receive digital data about a constraint.

15. The reinforcement learning model of claim 14, wherein the constraint is a maximum number of communications to send in a particular time period.

16. The reinforcement learning model of claim 1, further comprising the reinforcement learning model configured to aggregate data from multiple clients.

17. The reinforcement learning model of claim 1, wherein the reinforcement learning model is a neural network.

18. The reinforcement learning model of claim 1, further comprising the reinforcement learning model configured at the given point in time to perform a comparison of an output of the reinforcement learning model to an actual output generated from application of the output.

19. The reinforcement learning model of claim 18, further comprising the reinforcement learning model configured at the given point in time to update to the reinforcement learning model.

20. The reinforcement learning model of claim 1, wherein the action is prioritizing between communications.
